(19) United States
(12) Patent Application Publication
(10) Pub. No.: US 2016/0050954 A1
(43) Pub. Date: Feb. 25, 2016

(54) NOVEL CONFECTIONERY WITH IMPROVED CRUNCHINESS

(71) Applicant: ROQUETTE FRERES, Lestrem (FR)

(72) Inventors: ANTOINE BARRE, SAINT ANDRE LEZ LILLE (FR); DOMINIQUE ORTIZ DE ZARATE, MERVILLE (FR); PATRICE DEMEULEMEESTER, LINSELLES (FR)

(21) Appl. No.: 14/781,921

(22) PCT Filed: Apr. 4, 2014
(86) PCT No.: PCT/EP2014/056772

§ 371 Date: Oct. 2, 2015

(30) Foreign Application Priority Data
Apr. 4, 2013 (FR) 1353050

(51) Int. Cl. A23G 4/10; A23G 4/20

(52) U.S. Cl. CPC A23G 4/10; A23G 4/20; A23V 2002/00

(57) ABSTRACT

The present invention concerns a novel composition for a non-cariogenic confectionery or pharmaceutical product obtained by a hard sugar-coating method, and having improved crispiness relative to the prior art products. The invention also concerns the method of implementing said composition in the production of a non-cariogenic sugar-coated chewing-gum, characterised in that it helps considerably reduce the time taken to produce said products.

### FIELD OF THE INVENTION

The present invention relates to a novel composition for a non-cariogenic pharmaceutical or confectionery product obtained via a hard sweet-coating process and having improved crispiness relative to the prior art products. The invention also relates to the process for preparing said composition in the manufacture of a sweet-coated non-cariogenic chewing gum, characterized in that it can considerably reduce the manufacturing time of said products.

### TECHNICAL BACKGROUND

Man has known about chewing for a very long time, long before the arrival of chewing gum. Indeed, prehistoric men already used to chew conifer sap, leaves, plant secretions and roots. In Mexico, the Mayas, more than 3000 years ago, used to chew sapote sap, a kind of latex known as “chicle”. In 400 BC, the Greeks used to chew resin, and the Amazonian Indians chewed balls of tobacco or wads of coca extracted from small Peruvian shrubs: the cola tree.

However, it was not until the XIXth century that chewing gum as we know it today appeared.

In 1869, the patent for chewing gum was filed by the dentist William Finley Semple, who was convinced of its beneficial effects for the teeth, but he did not market his invention. It was in about 1870 that Thomas Adams of New York had the idea by developing a machine for producing chewing gum. By mixing chicle, resin and syrup, he manufactured and marketed the first chewing gums in 1872.

Today, France has become the 2nd worldwide consumer of chewing gum, behind the United States. Chewing gum can be consumed at any time of the day. It is the ideal product when a person wishes to consume something pleasant or to eat a sweetmeat. Furthermore, irrespective of its flavor, chewing gum makes the breath fresh and plays a hygiene and social role. 53% of people chew chewing gum to freshen their breath. Chewing gum is increasingly appearing as a substitute to toothpaste. 39% of people chew chewing gum to clean their teeth when they cannot brush them. Chewing gum is especially consumed after meals since it facilitates digestion by promoting the secretion of saliva and the work of the stomach. Many consumers use chewing gum as an anti-stress agent or as a means for reducing nervous tension and for relaxing. 30% of people like chewing chewing gum when they are irritated and 27% become calm on chewing gum. Chewing gum is also considered as an effective substitute for smoking. In a time when the legal measures directed toward reducing tobacco consumption are on the strong increase, chewing gum still has bright perspectives for development.

Chewing gum (or chiclette) is a gum to which are added flavorings and food fragrances, intended to be chewed. All chewing gums are manufactured from a base gum to which are added flavorings and sugar and/or sweeteners to give the taste. Chewing gum is a mixture of two phases: a liquid phase (syrup, diluted sugars and/or sweetener) and a solid phase composed of the base gum and crystalline sugar and/or sweetener.

At the present time, chicle, the natural base gum derived from the trunk of sapote trees, but which has become too expensive due to the rarity of the trees and the excessively high production and transportation costs), has been replaced with a synthetic product (base gum) which is composed of:
1 or 2 elastomers that determine the elasticity,
waxes for lowering the softening point and which have anti-tack and plasticizing power,
mineral fillers which improve the mechanical qualities,
an antioxidant which protects the qualities of the gum during manufacture and which protects it from aging,
resins which bind together the starting materials of the gum.

The dosage of these 5 ingredients determines the type of gum (chewing gum or bubble gum). The recipe often remains secret because it is not constant. It varies as a function of the price of the starting material. The constituent ingredients of the base gum are water-insoluble. On the other hand, the majority of the constituent ingredients of chewing gums, except for the base gum, are soluble in water (i.e. in this case saliva). After 3 to 4 minutes of chewing, the compounds are extracted (dissolved) by the saliva, resulting in the loss of taste of the chewing gum. The base gum and a few flavorings that are not water-soluble remain in the mouth.

The base gum is a product that is complex to manufacture: the ingredients are dosed rigorously to obtain more or less elastic gums. The ingredients are blended for between ninety minutes and two hours in a kneader which operates like bakery kneaders. The kneading heats the gum. It finally reaches a temperature of 95° C. to 98° C. The elastomer used (in place of chicle) is a food-grade isobutylene-isoprene (butyl) copolymer.

The flavorings, sweeteners or sugar and also various additives and manufacturing auxiliaries (colorant, gelatin, emulsifier, stabilizer, gelling agent, bicarbonate, carnauba wax) are added to this base. The ingredients and the base gum are mixed in a kneader for 15 to 20 minutes.

At the end of kneading, the paste reaches a temperature of about 50° C. The chewing gum paste is placed in an extruder. Once correctly pressed, it forms more or less thick strips. The strips then pass through the roller and are cut into tablets or cores also known as centers. After cooling, the tablets or centers are maintained at a controlled temperature and humidity for 6 to 48 hours. This phase is carefully controlled, since the quality of the chewing gums is dependent thereon.

The tablets are enveloped in aluminum wrapping to conserve all their taste. They are then placed in packets. The centers are sweet-coated before being wrapped in cardboard or plastic containers.

The present invention relates solely to chewing gum sweet-compositions coating, i.e. those obtained after sweet-coating of the cores.

The present invention also relates only to non-cariogenic chewing gum compositions, sweet-coated with polyols.

Sugar-free chewing gum is now the top-selling product, with a 90% market share in the majority of the European countries. By virtue of the polyols, chewing gums are non-cariogenic, less calorific and have an excellent taste.

The tendency toward healthier food is continuing to gain ground and is significantly modifying modes of consumption and purchasing habits. Eating less sugar while continuing to afford themselves indulgences is the desire of an ever-increasing number of consumers in response to the numerous nutritional recommendations. The use of sugar substitutes as a replacement for sugar is justified for the manufacture of foodstuffs of reduced energy value, non-cariogenic foodstuffs and foods with no added sugar, and also for the production of dietetic products.

From the point of view of confectionery industrialists, very strong intentions also emerge. Those of manufacturing non-cariogenic confectionery, i.e. confectionery that does not cause tooth decay since the products it contains do not produce acids and are not metabolized by the bacterial oral flora.

Industrialists are seeking to obtain confectionery that satisfies the very strict specifications of the Association Sympadent Suisse, so as to be able to display on their confectionery the label known and recognized by all. This label, a small person in the form of a tooth with an umbrella, was created by Action Sympadent to denote dentition-friendly products and thus to serve as an indicator in the service of behavior that preserves the dentition. These products must be neither cariogenic nor erosive. Various types of sugars are cariogenic, which means that they are capable of causing caries. The detrimental erosive potential however depends on the acid content of a product.

Products bearing the Sympadent label must first pass a scientific test known as the “measurement of the pH by telemetry”. This test is performed by independent test centers. It is a normalized procedure in which the pH of dental plaque is measured on experimental individuals by placing electrodes covered with plaque in the interdental spaces. The measurement takes place during the consumption of the confectionery to be tested and thirty minutes after its consumption. The confectionery is considered non-cariogenic if the pH does not fall below the critical threshold of 5.7. The erosive potential is determined using an electrode without plaque placed in the saliva. The products that expose the teeth to less than 40 μmol of acid during their consumption are considered as being non-erosive.

The smiling tooth under its umbrella is an understandable symbol throughout the world. It is understood without further explanation. Products bearing it are friendly to the teeth. This pictogram and the normalized indications of the nutritive values contribute toward healthy food that is respectful to the teeth. A consumer would rather be tempted to purchase confectionery bearing this logo.

Irrespective of the age of the consumers, there is a permanent desire to have quality products. The quality of chewing gums is measured by several parameters, including the texture of the chewing gum (rather hard or, on the other hand, rather soft, persistent crunchiness of the sugar coatings during chewing) and the taste (sweet taste, freshness effect or otherwise, persistence of the flavor during chewing). Specifically, consumers very often complain that both the crunchiness and the taste disappear too quickly during chewing.

Numerous research studies have already been conducted on the persistence of the taste by many companies. The Applicant has also worked on this subject and mention may be made in this respect of patent EP 0 664 960 B in which the Applicant demonstrated that it was possible to improve the organoleptic quality of a chewing gum, and especially to improve the taste and flavor in terms of impact and duration, by incorporating therein, as pulverulent phase, maltitol with a maltitol purity of greater than 95% and a particle size such that 50% of the maltitol particles in the chewing gum are less than 90 microns in size.

In wishing to further improve upon the prior art and above all to satisfy the ever more demanding expectations of consumers, the Applicant thus set itself the task of obtaining a novel non-cariogenic chewing gum with improved crunchiness, i.e. whose crunchiness persists for longer during chewing when compared with the conventional chewing gums of the prior art.

### SUMMARY OF THE INVENTION

After numerous research studies, the Applicant has found, surprisingly and unexpectedly, that it is possible to obtain a chewing gum with persistent crunchiness during chewing.

The present invention relates to a non-cariogenic chewing gum composition with improved crunchiness, characterized in that it comprises a base gum, a flavoring and a non-cariogenic carbohydrate in the form of a powder with a mean particle size of greater than 300 μm, preferably from 500 μm to 800 μm and even more preferentially from 650 μm to 750 μm, and a sugar-free coating.

According to the present invention, said composition is characterized in that it comprises between 5% and 20% and preferably between 8% and 13% of a non-cariogenic carbohydrate powder with a mean particle size of greater than 300 μm.

According to the present invention, said composition is characterized in that the carbohydrate is chosen from polyols, but also from nonfermentable saccharides that may be chosen from the group consisting of isomaltulose, xylose, xylulose, allulose, arabinose, leucrose, tagatose, trehalulose and raffinose.

According to a preferential mode of the invention, said composition is characterized in that the carbohydrate is chosen from polyols.

According to another preferential mode of the present invention, it is characterized in that the polyol is chosen from the group comprising sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM), alpha-D-glucopyranosyl-1,1-sorbitol (=1,1-GPS) and any mixtures thereof, and preferably from maltitol, xylitol, sorbitol type 20/60, isomalt, isomalt type M or erythritol, and any mixtures thereof.

According to a preferential mode, said composition is characterized in that the polyol powder is a crystalline maltitol powder with a maltitol richness of greater than 99.5% by weight, preferably greater than or equal to 99.7% by weight and more preferentially greater than 99.8% by weight, having:
a volume-based particle size distribution, determined by laser granulometry, having:
   less than 20%, preferably less than 15%, more preferentially less than 10% and even more preferentially less than 5% of particles smaller than 200 μm in size,
   less than 6% of particles smaller than 100 μm in size,
   less than 2% of particles smaller than 40 μm in size, and
a flow value of less than or equal to 10 seconds, preferably less than or equal to 5 seconds,
an aerated density of greater than 0.85 g/ml, preferably between 0.88 and 1.00 g/ml, a tapped density of greater than 0.97 g/ml, preferably between 0.98 and 1.05 g/ml and a compressibility of less than 17%, preferably less than 10% and even more preferentially less than 5%.

Another embodiment of the invention concerns a non-cariogenic chewing gum composition with improved crunchiness, characterized in that it comprises:
from 15% to 40% of base gum,
from 65% to 80% of polyols in pulverulent and/or liquid form, at least 5% to 20% of which are in the form of a polyol powder with a mean particle size of greater than 300 μm,
from 0.2% to 3% of a flavoring agent,
   and in that it is sweet-coated.

The invention also relates to a process for manufacturing a non-cariogenic sweet-coated chewing gum, characterized in that it comprises the following steps:
manufacture of a chewing gum composition by mixing at least one base gum, a flavoring and a non-cariogenic carbohydrate in the form of a powder with a mean particle size of greater than 300 μm,
extrusion of the preceding mixture,
rolling,
cutting,
cooling, and
sweet-coating of the centers thus obtained.

According to the present invention, the process is characterized in that the sweet-coating step comprises one or more cycles each comprising a phase of application, generally by spraying, of a sweet-coating syrup (containing one or more polyols, but also occasionally binders such as gum arabic or gelatin, colorants such as TiO₂, intense sweeteners, etc.) onto the cores, a rotating phase for distributing said syrup over the cores, also known as the waiting time, and a phase of drying each new layer of syrup performed by blowing with hot, dry air.

According to the invention, the process is characterized in that the non-cariogenic carbohydrate particles have a mean particle size of greater than 300 μm, preferably from 500 to 800 μm and more preferably from 650 to 750 μm.

According to the present invention, the process is characterized in that the chewing gum composition comprises between 5% and 20% and preferably between 8% and 13% of a non-cariogenic carbohydrate powder with a mean particle size of greater than 300 μm.

The process according to the invention is characterized in that the carbohydrate is chosen from polyols, but also from nonfermentable saccharides which may be chosen from the group consisting of isomaltulose, xylose, xylulose, allulose, arabinose, leucrose, tagatose, trehalulose and raffinose.

According to a preferential mode of the invention, the process is characterized in that the carbohydrate is a polyol chosen from the group comprising sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM), alpha-D-glucopyranosyl-1,1-sorbitol (=1,1-GPS) and any mixtures thereof.

According to another preferential embodiment, the process is characterized in that the sweet-coating step is performed until degrees of enlargement of between 25% and 40% and preferably between 25% and 31% are obtained.

Finally, the invention also relates to the use of a chewing gum composition a base gum, a flavoring and a non-cariogenic carbohydrate in the form of a powder with a mean particle size of greater than 300 μm, preferably from 500 μm to 800 μm and even more preferentially from 650 μm to 750 μm, in a process for manufacturing an abovementioned sweet-coated non-cariogenic chewing gum.

### DETAILED DESCRIPTION OF THE EMBODIMENTS

The present invention relates to a novel non-cariogenic chewing gum composition with improved crunchiness during chewing, characterized in that said chewing gum composition comprises crunchy particles of at least one non-cariogenic carbohydrate.

More precisely, the present invention relates to a novel non-cariogenic chewing gum composition with improved crunchiness during chewing, characterized in that it comprises a base gum, a flavoring and a non-cariogenic carbohydrate in the form of a powder with a mean particle size of greater than 300 μm, and a sugar-free coating.

In the present invention, the term “non-cariogenic” refers to chewing gum compositions that do not cause caries when they are consumed.

More precisely, the chewing gum compositions according to the invention bring about less acidification by the oral bacteria than chewing gum compositions containing standard sugars such as sucrose, glucose or fructose.

The non-cariogenic effect is in fact due to the presence in the oral cavity of a large number and a wide variety of bacteria, especially cariogenic bacteria (in particular mutant streptococci) which colonize dental plaque (or dental film) and metabolize and ferment food sugars, leading to the production of acids, especially lactic acid. These acids produce a lowering of the pH around the tooth below the crucial pH of 5.7, which has the consequence of dissolving the hydroxyapatite of the dental enamel and of creating cavities therein. The tooth is then embrittled since the high acidity causes demineralization (dissolution) of the dental enamel. The caries then progresses into the tooth and reaches the pulp, causing pain.

Specifically, repeated consumption and a long residence time in the mouth of foods rich in fermentable carbohydrates (containing sugar or sucrose, fructose, starch, etc.) form a terrain that favors the development of caries.

In the present invention, the term “non-cariogenic carbohydrate” means all unfermentable carbohydrates or non-acid-forming carbohydrates.

According to the present invention, the chewing gum composition is characterized in that the carbohydrate is chosen from polyols, but also from unfermentable saccharides which may be chosen from the group consisting of isomaltulose, xylose, xylulose, allulose, arabinose, leucrose, tagatose, trehalulose and raffinose. Specifically, these carbohydrates are incapable of being converted into acids by fermentation, and thus do not participate in the formation of caries. These unfermentable carbohydrates are not metabolized by the bacteria of the oral cavity and do not lead to the production of acid. There is therefore no lowering of the pH in the mouth below the critical value of 5.7 and the cariogenic and erosive risks do not appear.

Thus, the chewing gum compositions according to the present invention satisfy the Sympadent label.

In a preferential mode of the invention, the non-cariogenic carbohydrate is also sugar-free.

In an even more preferential mode, the non-cariogenic and sugar-free carbohydrate is chosen from polyols.

Throughout the present invention, it will be considered that all the percentages expressed, unless specifically mentioned otherwise, are expressed relative to the total weight of the chewing gum composition prepared.

In the present invention, the term “chewing gum” is used without a preference to denote chewing gums and bubble gums. The difference between these two types is, for that matter, rather vague. It is customary to say that chewing gums are chewed whereas bubble gums are intended for making bubbles, and are thus conventionally rather consumed by young consumers.

Most chewing gums, whether they are with or without sugar, and sweet-coated or otherwise, essentially comprise a water-insoluble base gum, water-soluble sweetening agents provided in liquid and/or pulverulent form and flavorings. They often comprise other ingredients such as colorants, emulsifiers, plasticizers, intense sweeteners, water, etc.

The base gum is the ingredient which differentiates chewing gums from other confectionery products. This elastic substance has the property of being able to be chewed for hours without any substantial changes in its texture being induced. It does not break down during chewing either. The base gum is a very important ingredient in the manufacture of the centers. It varies as a function of the finished product, chewing gum or bubble gum, the format in sticks or tabs, with or without sugar, etc. Base gums are nowadays really very different from those used in the past. They contain synthetic elastomers, plasticizers, softeners or softening agents, texturizers and emulsifiers and also a variety of specific ingredients that give the product its particular properties as a function of the final application.

The base gum constituting the chewing gum composition according to the invention is preferably ordinary and similar to those commonly used. It may represent, depending on whether it is a chewing tablet, a bubble gum, a center for sweet-coating or a low-calorie chewing gum, about 15% to about 50% of the composition in accordance with the invention.

Its nature is also adapted to the type of chewing gum manufactured. It may also comprise synthetic and/or natural elastomers such as polyisoprene, polyvinyl acetate, polyisobutylene, latices, resins such as terpenic resins, polyvinyl alcohols and esters, fatty substances or waxes, for instance lanolin, partially hydrogenated or nonhydrogenated plant oils, fatty acids, partial glycerol esters, paraffin, microcrystalline waxes, fillers such as talc, calcium carbonate, elastomeric plasticizers such as glyceryl triacetate or glyceryl monostearate, rosin derivatives, emulsifiers such as lecithin, sorbitol esters, colorants or whitening agents, antioxidants, and non-stick agents such as mannitol.

According to a preferential mode, the base gum content of the chewing gum composition in accordance with the invention is between 15% and 40%.

According to a preferential mode, the base gum content of the chewing gum composition in accordance with the invention is between 25% and 35%.

The manufacture of the sugar-free chewing gum or bubble gum centers, also known as tabs, requires the mixing of the base gum as described previously with polyols, used as filling sweeteners. Typically, the base gum represents between 25% and 35% of the centers, and the polyols between 65% and 80%, the rest possibly consisting of flavorings and/or intense sweeteners such as aspartame or acesulfame-K.

In a second embodiment of the invention, the filling sweeteners consist of unfermentable saccharides that may be chosen from the group consisting of isomaltulose, xylose, xylulose, allulose, arabinose, leucrose, tagatose, trehalulose and raffinose.

In another secondary embodiment, the filling sweeteners consist of a mixture of unfermentable saccharides and polyols that may be chosen from the group consisting of isomaltulose, xylose, xylulose, allulose, arabinose, leucrose, tagatose, trehalulose and raffinose.

In a preferred embodiment of the invention, the filling sweeteners consist solely of polyols.

Thus, the chewing gum composition according to the invention contains between 65% and 80% of polyols, in pulverulent and/or liquid form.

The polyols play a crucial role in the manufacture of the sugar-free chewing gum centers, both in the final quality of the product obtained (sweet-taste impact and “long-lasting” effect, impact on the flavor and “long-lasting” effect, crunchiness, hardness, chewability), but also in the process for preparing said centers. Typically, the main polyols used in the production of sugar-free chewing gum or bubble gum are maltitol, sorbitol, isomalt, mannitol and xylitol. These polyols are used both in powdery crystalline form and in liquid form in the formulation of these centers.

The choice of the particle size of the polyol powders is very important. To avoid obtaining an unpleasant sandy texture in the mouth, it is known practice to use the following particle sizes: sorbitol powder 200 μm in diameter, mannitol powder 60 μm in diameter, xylitol powder 90 μm in diameter and maltitol powder 35 μm in diameter. As sugar crystals, maltitol, mannitol and xylitol crystals have a more or less cubic form. Thus, in order to avoid a sandy texture on the tongue during chewing, these crystals must have a small particle size. Sorbitol particles have a dendritic microscopic structure, i.e. as an entanglement of needles. This particular structure makes it possible to use a sorbitol powder with a mean particle size of 200 μm without inducing a sandy texture in the mouth.

Among the bulk sweeteners or filling sweeteners that are polyols, it may in particular prove to be advantageous to use mannitol to prolong the sweet taste, erythritol and xylitol to afford a certain freshness due to their “cooling effect” property, pulverulent sorbitol or a maltitol powder with a purity of less than 95% to adjust the texture and to make it firmer. When a maltitol powder with a purity of between 82% and 94% is added, for example for this purpose, it may optionally be added as a premix in any proportion with pulverulent maltitol with a purity of greater than 95%, or alternatively with another ingredient of the composition according to the invention. This composition may also comprise intense sweeteners such as aspartame, alitame, acesulfame or sucralose, in free and/or encapsulated form.

During the first phase of production of the chewing gum centers, which consists in kneading al the ingredients included in the composition at a temperature of between 50° C. and 80° C., the liquid phase and the base gum coat the crystalline sweeteners and dissolve them to the point of saturation of the liquid phase. However, as the temperature decreases during the cooling process, the solubility of the polyols also decreases and the dissolved crystalline phase recrystallizes partially, which will lead to hardening of the chewing gum. Thus, the role of the liquid phase is to control the recrystallization of the crystalline sweeteners so as to prevent excessive fragility or hardening of the chewing gums during production, but also during storage. If the anti-crystallization syrup contains a significant amount of dissolved polyols similar to those of the crystalline phase, the crystallization during the production process or during storage will take place and lead to chewing gums that are too fragile or too hard.

The water of the chewing gum may be provided in the form of free water or by other constituents.

The chewing gum composition according to the invention may comprise a binding agent, in a concentration of from 0.1% to 30%. This may be chosen preferably from water, glycerol, hydrogenated or nonhydrogenated mono-, di-, oligo- or polysaccharide syrups, and syrups of low-calorie fillers and any mixtures thereof.

The mono-, di-, oligo- or polysaccharide syrups may be, for example, xylitol, sorbitol, maltitol, lactitol, isomaltulose, hydrogenated isomaltulose, erythrose or erythritol syrups, syrups, which are preferably hydrogenated, derived from the hydrolysis of starches or inulins, containing oligosaccharides and/or polysaccharides. As regards the syrups of low-calorie fillers, it is preferred in particular to select polydextrose, polyglucose or dextrin syrups.

According to a preferential embodiment, the chewing gum composition may contain up to 20% of a maltitol syrup.

By way of example, mention may be made of the maltitol syrups sold by the Applicant under the brand name Lycasin®, such as Lycasin® 80/55 (75% solids and 50-55% of maltitol solids), Lycasin® 85/55 (85% solids and 50-55% of maltitol solids). These ready-to-use anti-crystallization syrups or agents are particularly suitable for combined use with all the crystalline polyols mentioned below, and can thus give the chewing gum improved plasticity.

The chewing gum composition in accordance with the invention also contains a flavoring agent. This agent may comprise natural and/or synthetic compounds. It may in particular be mint, cinnamon, orange, lemon or lime flavorings, or flavorings corresponding to other fruit or plants, for instance apple, strawberry, banana or cherry flavorings or mixtures of fruit.

The flavoring agent is used in an appropriate amount that is readily determined by a person skilled in the art via simple routine tests, taking into account the nature of the base gum, the amount of base gum, the type of chewing gum and the characteristics of this flavoring agent. Normally, it will be used in a content of between about 0.2% and about 3%. Preferably, amounts sufficient to plasticize the base gum without it being excessively softened will be selected, especially for the hydrophobic flavoring agents. To do this, a content of flavoring agent of between 0.7% and 2.5% will rather be selected, the ideal being to select a content of between 1% and 2%.

The dosage of flavoring agent will also depend on the richness thereof of flavoring compounds, i.e. of compounds really having a retro-olfactory effect. Furthermore, this dosage will vary with the physical nature of the flavoring agent. For example, for an encapsulated form, the dosage will normally be lower.

The flavoring agent may be in the form of a single product or in two or more different physical forms essentially comprising the same flavoring compounds. Use may also be made of several flavoring agents of different nature and of identical or different physical states.

Food acids may also be added to the composition in accordance with the invention, for example as enhancers, in small amounts, especially when a fruit flavoring is employed.

The ingredients and the base gum are mixed in a kneader for 15 to 20 minutes. At the end of kneading, the paste reaches a temperature of about 50° C. The chewing paste is then poured into an extruder. Once it is well pressed, it forms more or less thick strips. The strips then pass through the roller and are cut into tablets or cores. After cooling, the tablets or cores for sweet-coating are maintained at a precise temperature and humidity for 6 to 48 hours. This phase is rigorously controlled, since the quality of the chewing gums is dependent thereon.

Thus, the present invention relates to a novel sugar-free chewing gum composition with improved crunchiness on chewing, characterized in that said chewing gum composition has crunchy particles of non-cariogenic carbohydrate, and preferably of polyols, with a mean particle size of greater than 300 μm, and a sugar-free coating.

Specifically, the Applicant has found, after long research studies, that the organoleptic quality, and more particularly the crunchiness of a chewing gum, can be improved by providing in its center crunchy particles of non-cariogenic carbohydrate, and preferably of polyols having a certain particle size.

In the present invention, the non-cariogenic carbohydrate particles are added directly to the base gum during the preparation of the centers. These particles with a mean particle size of greater than 300 μm, and preferably between 500 and 800 μm, are blended in the kneader with the base gum especially, and are thus intimately mixed and bound to said base gum, to finally form a single homogeneous mass. The centers obtained are thus uniform and do not consist of several layers as already known in the prior art.

Even more precisely, the carbohydrate particles are added directly into the kneader with the gum, without undergoing a particular pretreatment to give them the desired crunchiness. Specifically, the carbohydrate particles are added directly and “just as they are” to the base gum and it is their particular particle size that directly gives the centers the crunchy nature.

Furthermore, the Applicant has also demonstrated that by coating said composition with a sugar-free coating obtained via a sugar-free hard sweet-coating process, the confectionery obtained is characterized by two levels of crunchiness. The first level is given by the hard sweet-coating process and the second by the crunchy particles of carbohydrates, and preferably of polyols, present in the center of the confectionery.

Thus, the confectionery obtained is doubly crunchy and offers the consumer a “long-lasting” crunchy effect, i.e. an effect that persists over time during chewing.

In the present invention, the expression “improvement of the organoleptic quality” will be understood as meaning improving the texture of the chewing gum and more particularly its crunchiness.

The crunchiness of sweet-coated products is a complex, subjective concept in which several factors must be assessed, such as the characteristics of the center, the thickness of the coating, the amount of coating binders, the water content, the hardness and friability of the coating, etc.

More pragmatically, the crunchiness is defined as being the crunchy sensation under the teeth, which persists for a longer or shorter amount of time during chewing. Hitherto, the crunchiness of a chewing gum was obtained solely by the outer layer which breaks into small pieces that are still crunchy, contrasting with the core of the sweet-coated product. The ideal sweet-coated product should be slightly resistant under the teeth, be crunchy, and then mix in small pieces with the soft center of the chewing gum to form an assembly with contrasting textures. The challenge for chewing gum manufacturers is to propose sweet-coated products that are crunchy not only when purchased, but also during consumption, which occasionally is a long time after, while the chewing gums have been subjected to impacts or exposure to moisture, or even to tropical conditions.

Thus, the invention relates to a novel sugar-free chewing gum composition having improved crunchiness when chewed, characterized in that it comprises a base gum, a flavoring and a non-cariogenic carbohydrate in the form of a powder with a mean particle size of greater than 300 μm, and a coating that is preferentially sugar-free.

The crunchiness of the chewing gum composition according to the invention is not only imparted by the outer layer, but also by the center of the sweet-coated product into which are incorporated the non-cariogenic carbohydrate particles whose particle size contributes toward the crunchiness.

In a preferential mode of the invention, the chewing gum composition is characterized in that the non-cariogenic carbohydrate particles present in the center have a mean particle size of from 500 to 800 μm.

In an even more preferential mode, the composition according to the invention is characterized in that the non-cariogenic carbohydrate particles present in the center have a mean particle size of from 650 to 750 μm.

The Applicant has found, in point of fact, that this quite specific particle size range for the carbohydrate particles is particularly advantageous, since it affords great satisfaction from the point of view of the crunchiness. When the particle size of the carbohydrate particles is not within this preferential range from 650 μm to 750 μm, the crunchy effect is still present, but not as pronounced. There is therefore a threshold effect for the particle size. Either below or above this range, the crunchy effect is less pronounced.

For the purposes of the present invention, the term “mean particle size” means a mean particle diameter. These values are determined with an LS 230 type laser scattering particle size analyzer from the company Beckman-Coulter, equipped with its powder dispersion module (dry route), according to the manufacturer's technical manual and specifications. The operating conditions of the screw speed under the hopper and of the vibration intensity of the dispersion chute are determined so that the optical concentration is between 4° and 12°, ideally 8°. The measuring range of the LS 230 type laser scattering particle size analyzer is from 0.04 μm to 2000 μm. The results are calculated as a volume percentage, and expressed in μm. The particle size distribution curve also makes it possible to determine the value of the volume mean diameter (arithmetic mean) D4.3.

In a preferential mode, the chewing gum composition is characterized in that it comprises between 5% and 20%, preferably between 8% and 13%, of a non-cariogenic carbohydrate powder with a mean particle size of greater than 300 μm.

The numerous tests performed by the Applicant in fact made it possible to demonstrate that this quite specific percentage of carbohydrate powder in the chewing gum composition makes it possible to obtain particularly advantageous results in terms of crunchiness.

In a particular embodiment, the chewing gum composition comprises between 8% and 13% of a non-cariogenic carbohydrate powder with a mean particle size of between 650 and 750 μm.

The content of non-cariogenic carbohydrate powder with a particle size of greater than 300 μm is adjusted in each recipe as a function of the final level of crunchiness that it is desired to obtain. The greater the desired crunchiness, the higher the content of crunchy particles of non-cariogenic carbohydrate used. This content is also to be adapted relative to the properties of the base gum used. A person skilled in the art is entirely capable of determining the amount of non-cariogenic carbohydrate particles to be incorporated into the manufacture of the chewing gum centers to be sweet-coated as a function of the hardness and elasticity properties of the base gum.

In a preferred embodiment of the invention, the non-cariogenic carbohydrate is chosen from polyols.

In the present invention, the term “polyols” denotes products obtained by catalytic hydrogenation of simple reducing sugars, thus having a DP equal to 1 (DP=degree of polymerization), but also more complex reducing sugars composed of higher homologs with a DP of greater than or equal to 2 of these simple sugars, such as disaccharides, oligosaccharides and polysaccharides, and also mixtures thereof. Generally, the simple reducing sugars that are intended for catalytic hydrogenation to obtain polyol compositions of the type such as those of the invention are glucose, xylose, fructose and mannose. The polyols obtained are then sorbitol, xylitol and mannitol. The disaccharides are usually maltose, maltulose, isomaltulose and lactose, which lead by hydrogenation to maltitol, isomalt, isomaltitol and lactitol. The oligosaccharides and polysaccharides, which are products of higher molecular weights, are normally derived from an acidic and/or enzymatic hydrolysis of tuber and/or non-tuber starches, of xylans or fructans such as inulin, but may also be obtained by acidic and/or enzymatic recombination of mono- or disaccharides such as those mentioned above.

Consequently, in the present invention, the term “polyol” denotes a polyol chosen especially from the group comprising sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM), alpha-D-glucopyranosyl-1,1-sorbitol (=1,1-GPS) and mixtures thereof.

In a preferential mode of the invention, the chewing gum composition is characterized in that it comprises a polyol powder for providing the crunchy particles, chosen from maltitol, xylitol, sorbitol type 20/60, isomalt, isomalt type M, or erythritol, and any mixtures thereof.

In a more preferential mode, the chewing gum composition is characterized in that the polyol powder used is a crystalline maltitol powder with a maltitol richness of greater than 99.5% by weight, preferably greater than or equal to 99.7% by weight and more preferentially greater than 99.8% by weight, characterized by:
a volume-based particle size distribution, determined by laser granulometry, having:
   less than 20%, preferably less than 15%, more preferentially less than 10% and even more preferentially less than 5% of particles smaller than 200 μm in size,
   less than 6% of particles smaller than 100 μm in size,
   less than 2% of particles smaller than 40 μm in size, and
a flow value of less than or equal to 10 seconds, preferably less than or equal to 5 seconds,
an aerated density of greater than 0.85 g/ml, preferably between 0.88 and 1.00 g/ml, a tapped density of greater than 0.97 g/ml, preferably between 0.98 and 1.05 g/ml, and a compressibility of less than 17%, preferably less than 10% and even more preferentially less than 5%.

The crystalline maltitol powder of this preferential mode of the invention is above all characterized by the low content of small-sized particles.

By way of example, mention may be made of the maltitol powder developed by the Applicant, sold under the name SweetPearl® P700, and protected in patent application EP 2249870.

In a particular implementation example, the chewing gum composition comprises between 8% and 13% of a maltitol powder with a mean particle size of between 650 and 750 μm. According to another implementation example, the chewing gum composition comprises between 8% and 13% of an isomalt powder with a mean particle size of between 650 and 750 μm.

It has been known for a very long time to add to the base gum polyols either in powder form or in liquid form, or in both forms. However, it is only known practice to use polyol powders having a low or fine particle size, as described previously in the present application, so as to overcome a sandy or grating texture in the mouth.

Thus, the Applicant has overcome a veritable technical prejudice by incorporating into chewing gum centers a polyol powder having a coarser particle size than the chewing gum compositions described hitherto in the prior art, without, however, obtaining an unpleasant texture in the mouth. On the contrary, the organoleptic qualities of the finished products were far superior in terms of crunchiness than the products manufactured hitherto.

According to a preferential mode, the present invention relates to a non-cariogenic chewing gum composition of improved crunchiness, characterized in that it comprises:
from 15% to 40% of base gum,
from 65% to 80% of polyols in pulverulent and/or liquid form, of which 5% to 20% are in the form of a polyol powder with a mean particle size of greater than 300 μm,
from 0.2% to 3% of a flavoring agent, and in that it is sweet-coated.

Specifically, not only did the Applicant find that the “long-lasting” effect of the crunchiness of a sweet-coated sugar-free chewing gum could be improved by incorporating therein carbohydrate particles, and preferably polyols, of coarse particle size in the center, but it also demonstrated that with this incorporation it was entirely possible to obtain a sweet-coated confectionery that is crunchy on the exterior with sweet-coating times that are considerably reduced relative to the known processes of the prior art.

Specifically, the Applicant has demonstrated that the incorporation of carbohydrate particles, and preferably of polyols, of coarse particle size into the center made it possible to perform fewer and thus shorter sweet-coating cycles to achieve a better final result in organoleptic terms.

In another embodiment of the invention, the Applicant has also found that the crunchy sensation of the centers could also be provided by inclusions of another type.

Thus, and in a nonlimiting manner, the crunchy particles contained in the centers may also consist of ground cooked sugars, of ground tablets, of ground caramels or any other confectionery that can be ground, ground dried fruit, ground biscuits, ground cornflakes or other cereals, or any other food which, once ground, can also give a crunchy nature to the chewing gum centers.

In this quite specific case, the content of inclusions other than the carbohydrate particles will be adjusted by a person skilled in the art so as to maintain a certain cohesion in the base gum during its blending with these inclusions.

The novel composition makes it possible to obtain a chewing gum with double crunchiness, i.e. a first crunchy sensation provided by the coating which will be broken into small pieces under the teeth, but also by particles included in the center, which will also reinforce the crunchiness of the chewing gum. This persistent effect of the crunchiness is defined in the present application as “long-lasting” crunchiness.

Thus, this double-crunchiness effect makes it possible to considerably reduce the sweet-coating times, and consequently enables a very substantial financial saving for sweet-coated chewing gum manufacturers without impairing the final quality of the sweet-coated products, but rather improving the organoleptic qualities.

It has been known for a long time that sweet-coated chewing gums have a crunchy effect. It is moreover this aspect that is sought by many consumers of this type of confectionery.

The Applicant has conducted in the past numerous studies in this matter and has succeeded in demonstrating that polyols, in addition to their non-cariogenic aspect, make it possible to obtain products with persistent crunchiness and sweet taste in the mouth, which are identical to those afforded by conventional sugar-coated confectioneries. Technically, this is explained by a significant resistance to water uptake of sweet-coated products and to excellent stability over time. These research studies related essentially to the polyols used in the sweet-coating syrups. The Applicant has demonstrated in its past studies that, depending on the polyol used, more or less crunchy sweet-coated products could be obtained. The level of crunchiness depended not only on the polyol used, but also on the thickness of the coating. The greater the coarseness, i.e. the thickness of the crunchy layer, the more pronounced the crunchy effect.

The coarseness, also known as the final proportion of coating, is defined by the weight increase of the products. It is calculated by the weight ratio of the finished (sweet-coated) product to the weight of the center or core before sweet-coating.

Now, the present invention once again goes against this established prejudice which has been held for a very long time. With smaller degrees of coarseness, but by virtue of the presence of polyol particles of large particle size in the center, it is entirely possible to obtain sweet-coated chewing gums with a long-lasting crunchy effect.

The hard sweet-coating is directed toward obtaining a sweet crunchy layer, which is always highly appreciated by consumers.

Hard sweet-coating is a unit operation employed in many fields and especially in confectionery or in pharmaceutics. It may also concern the industry of additives such as flavorings, sweeteners, vitamins, enzymes, acids and plant-based products. This operation consists in creating a hard coat at the surface of solid or pulverulent products, so as to protect them for various reasons or so as to make them visually or gustatively attractive.

The coating of the core is performed in a tank rotating about its axis, known as a coating drum, inside which is a plurality of cores forming a mass in motion, at the surface of which the material constituting the future envelope is distributed in liquid form.

Hard sweet-coating always requires the use of a syrup containing crystallizable materials. The hard crystalline coat is obtained by applying this syrup and evaporating off the water supplied therein. This drying step is performed by blowing with warm air whose temperature is adjusted as a function of the hardness of the centers.

The term “hard sweet-coating” used in the present invention will also comprise very similar techniques, namely glazing and frosting. Glazing consists of one or two applications or charges of a crystallizable syrup that is dilute relative to that used in hard sweet-coating. The aim is often to finish the surface appearance of sweet-coated products. Hard sweet-coating is often followed by glazing. Frosting is also directed toward improving the appearance of the products, but also toward isolating them from atmospheric moisture. This technique resembles hard sweet-coating, in the sense that a crystalline syrup is used. The essential difference lies in the fact that the number of sweet-coating cycles performed is only one, two or three.

Sweet-coating is a long and laborious process, including a large number of successive steps. Each of these steps, also known as the sweet-coating cycle, typically includes a phase of applying, generally by spraying, a sweet-coating syrup (containing one or more polyols, but also occasionally binders such as gum arabic or gelatin, colorants such as TiO₂, intense sweeteners, etc.) to the cores, a rotating phase for distribution of said syrup on the cores, also known as the waiting time, and a phase of drying each new layer of syrup performed by blowing with hot, dry air. This succession of cycles must be repeated a very large number of times, of the order of ten to eighty times, so as to obtain the desired degree of enlargement.

The thickness of the envelope or degree of enlargement is chosen especially as a function of the core to be sweet-coated or of the desired effects. Nowadays, the major preoccupation of chewing gum manufacturers is to obtain chewing gums that have a crunchy hard layer, but while reducing the sweet-coating times.

It is entirely known from the prior art that sweet-coated chewing gums with good crunchiness must have a degree of enlargement of at least 30% and preferably of at least 40%.

The present invention makes it possible to obtain chewing gums with excellent crunchiness with degrees of enlargement of only 25%, which represents a decrease of at least 20% in the degree of enlargement relative to the sweet-coated chewing gums of the prior art. The manufacturing times are thus considerably shortened.

Sugar-free hard sweet-coating has been known for a long time and many studies have been conducted for reducing the sweet-coating times while at the same time allowing the production of quality products. For example, a method directed toward improving the state of the art, and especially for obtaining sweet-coated products of very good quality, with relatively short sweet-coating times, shorter than the processes known in the prior art, was described in patent application EP 1 481 597, of which the Applicant is the proprietor. This method makes it possible to obtain hard, crunchy coats at the surface of a core, and comprises at least one sweet-coating cycle which comprises a step of applying a sweet-coating syrup with a richness of greater than 80% (the richness being the content of polyol concerned relative to the solids content of the sweet-coating syrup) followed by a step of drying the cores and characterized in that the cycle does not comprise a waiting time between the step of applying the sweet-coating syrup and the step of drying the cores.

Application EP 2108264, of which the Applicant is also the proprietor, also describes a sugar-free hard sweet-coating process for creating a hard coat at the surface of a core in less than two hours using a particular process.

In all the processes described hitherto in the prior art, it was always sought to reduce the sweet-coating times. Each time, the products obtained had degrees of enlargement of between 30% and 40% and more particularly of the order of 35%.

The present invention relates to a hard sweet-coating process for obtaining products whose organoleptic quality is superior to that of the products of the prior art and characterized in that the degrees of enlargement are reduced by at least 20% relative to the degrees of enlargement described in the prior art processes. The manufacturing times are thus also considerably shortened. Another considerable advantage is that the amount of products used for the sweet coating is considerably reduced. The financial advantage is thus twofold: reduction in the cost of the starting materials, but also in the process time.

Thus, the present invention relates to a process for manufacturing a non-cariogenic sweet-coated chewing gum, characterized in that it comprises the following steps:
manufacture of a chewing gum composition by mixing at least one base gum, a flavoring and a non-cariogenic carbohydrate in the form of a powder with a mean particle size of greater than 300 μm,
extrusion of the preceding mixture,
rolling,
cutting,
cooling,
sweet-coating of the centers thus obtained.

More precisely, said process for manufacturing a sweet-coated chewing gum according to the invention is characterized in that the chewing gum composition is obtained by blending in a kneader the base gum, the flavoring and the non-cariogenic carbohydrate in the form of a powder so as to obtain an intimate mixture that may also be characterized as a single homogeneous mass. The non-cariogenic carbohydrate particles are thus perfectly mixed with the base gum at the end of the blending step. The centers obtained are thus uniform and do not consist of several layers.

According to a preferential mode, the process is characterized in that the sweet-coating step comprises one or more cycles each comprising a phase of applying, generally by spraying, a sweet-coating syrup (containing one or more polyols, but also occasionally binders such as gum arabic or gelatin, colorants such as TiO₂, intense sweeteners, etc.) to the cores, a rotary phase for distributing said syrup on the cores, also known as the waiting time, and a phase of drying each new layer of syrup, performed by blowing with hot, dry air.

The solids content of the sweet-coating syrup is between 60% and 90%, more preferably between 70% and 85% and even more preferentially greater than or equal to 76% and less than 80%.

The syrup used is brought to a temperature below 100° C. before application. In an advantageous embodiment, the temperature of the syrup is between 50° C. and 95° C. and even more advantageously between 70° C. and 80° C.

In a preferential embodiment of the invention, the sweet-coating step is performed until degrees of enlargement of between 25% and 40%, preferably between 25% and 31% and even more preferentially from 25% to 28% are obtained.

In a preferential mode, the process makes it possible to obtain quality products with a degree of enlargement reduced by at least 20% relative to the degrees of enlargement described in the prior art.

In a preferential mode of the invention, the process for manufacturing a non-cariogenic sweet-coated chewing gum is characterized in that the non-cariogenic carbohydrate particles have a mean particle size of from 500 to 800 μm.

In an even more preferential mode, the process according to the invention is characterized in that the non-cariogenic carbohydrate particles have a mean particle size of from 650 to 750 μm.

In an advantageous embodiment of the invention, the process is characterized in that the chewing gum composition comprises between 5% and 20% and preferably between 8% and 13% of a non-cariogenic carbohydrate powder with a mean particle size of greater than 300 μm.

In another embodiment of the invention, the process is characterized in that the carbohydrate is chosen from polyols, but also from unfermentable saccharides that may be chosen from the group consisting of isomaltulose, xylose, xylulose, allulose, arabinose, leucrose, tagatose, trehalulose and raffinose.

In another preferential embodiment of the invention, the process is characterized in that the carbohydrate is chosen from polyols.

In another preferential mode, the process is characterized in that the polyol is chosen from the group comprising sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM), alpha-D-glucopyranosyl-1,1-sorbitol (=1,1-GPS) and any mixtures thereof.

In an even more preferential mode, the process is characterized in that the polyol is chosen from maltitol, xylitol, sorbitol type 20/60, isomalt of type M and erythritol.

In many sweet-coating processes, the sweet-coating syrup may become tacky when it is applied to the cores and when it begins to dry. To reduce the tack, a polyol powder, also known as a filler, may be applied after the phase of applying/spraying the sweet-coating syrup onto the cores, to accelerate the drying of the coat before it becomes too tacky. It should be noted that the polyol predominantly present in the sweet-coating syrups may or may not be different in nature from the polyol mainly present in the filler. Other fillers may also be used, for instance talc or calcium carbonate (CaCO₃).

The sweet-coating syrup may be prepared from all polyols in powder form under the brand names SweetPearl® for maltitol and Xylisorb® for xylitol, which are both marketed by the Applicant. Use may also be made of ready-to-use syrups, for instance maltitol syrups with a high content of maltitol.

Another subject of the present invention consists of the use of an abovementioned chewing gum composition without coating in a process for manufacturing a sweet-coated non-cariogenic chewing gum.

Implementation of the invention as described above makes it possible to obtain sweet-coated products of very good quality with considerably reduced sweet-coating times, which are shorter than those of the processes described in the prior art.

Thus, the Applicant has demonstrated that the “long-lasting” effect of the crunchiness of a sweet-coated non-cariogenic chewing gum can be improved by incorporating therein non-cariogenic carbohydrate particles of coarse particle size in the center, but its research has also demonstrated that by modifying the water activity of the center, the effect on the crunchiness could also be improved.

Thus, the present invention relates to a non-cariogenic chewing gum composition with improved crunchiness, characterized in that it comprises a base gum, a flavoring and a carbohydrate in the form of a powder with a mean particle size of greater than 300 μm, and a sugar-free coating, said coating having a reduced degree of enlargement. In particular, the degree of enlargement of the compositions according to the present invention may be between 25% and 40%, preferably between 25% and 31% and more preferably still between 25% and 28%.

The invention will be understood more clearly with the aid of the examples that follow, which are intended to be illustrative but not limiting.

### Example 1

This example relates to the manufacture of a chewing gum composition according to the invention comprising a base gum, a flavoring and a polyol in the form of a powder with a mean particle size of greater than 300 μm, and a sugar-free coating.

The control was prepared with a chewing gum composition not containing polyol particles of coarse particle size.

All the percentages are expressed relative to the total weight of the chewing gum composition used.

The centers thus obtained were then sweet-coated.

1. Preparation of the Chewing Gum Compositions

### Ingredients Used in the Chewing Gum Compositions

| | Control | Composition |
|---|---|---|
| | composition | according to the |
| Ingredients | (%) | invention (%) |
| Base gum BG Optima | 30 | 30 |
| (Cafosa) | | |
| SweetPearl ® P35 | 60.60 | 50.50 |
| SweetPearl ® P700 | — | 9 |
| Maltitol syrup | 7 | 7.50 |
| Lycasin ® 85/55 | | |
| Glycerol | 0.50 | 0.35 |
| Mint/vanilla liquid | 1.50 | 1.50 |
| flavoring | | |
| Mint/vanilla powder | 0.20 | 1 |
| flavoring | | |
| Intense sweetener | 0.20 | 0.15 |
| (Aspartame) | | |
| TOTAL | 100 | 100 |

SweetPearl® P35 is a crystalline maltitol powder sold by the Applicant, with a very fine particle size, of about 35 μm.

SweetPearl® P700 is a maltitol powder sold by the Applicant, of coarse particle size, of about 700 μm and more generally between 650 μm and 750 μm.

Procedure for Preparing the Control Chewing Gum Compositions and Chewing Gum Compositions According to the Invention
Mixing: Procedure in minutes—Performed in a Z-arm kneader at 45° C. —Batch manufacture of 60 kg of center
   0 min: Introduce the molten base gum (stoved overnight at 50° C.) and half of the SweetPearl® P35.

### 3 min: Add the Lycasin® 85/55.

5 min: Add the other half of the SweetPearl® P35.
9 min: Add the glycerol.
10 min: Add the mint/vanilla powder flavoring.
12 min: Add the mint/vanilla liquid flavoring.
14 min: Add the SweetPearl® P700 (only for the batch of the composition according to the present invention).
15 min: Unload the kneader (the paste is at about 50° C.). Form cakes of about 2 kg and store them for 1 hour at 50% RH and at 20° C. The cakes must be at about 48° C. for the extrusion.

Extrusion (Togum TO—E82 Machine)
Nominal body temperature=36° C.
Nominal head temperature=39° C.

4-Post Rolling—2-Post Precutting (Togum TO—W191 Machine)
Sprinkling of the strip of chewing gum with a 90/10 mannitol/talc mixture.

Maturation
Store the precut plaques of tabs at about 15° C.-50% RH for about 24 hours before sweet-coating them.

2. Sweet-Coating

In this example, the sweet-coating step is performed with maltitol and a mint flavoring. Equipment used: Driacoater 1200 coating drum containing 50 kg of chewing gum tabs.

### 1. Composition of the Sweet-Coating Syrup: (76% Solids—90° C.)

| | Ingredients | Solids |
|---|---|---|
| | by weight | composition |
| Maltitol Maltisorb ® P200 | 25.000 kg | 94.0% |
| Titanium dioxide | 0.266 kg | 1.0% |
| Gum arabic (40% MS) | 3.320 kg | 5.0% |
| Water | 6.400 kg | |
| | | 100.00 |

2. Coating Parameters and Sequence (50 kg of Chewing Gums) Phase 1=Dust removal and preheating

| | Phase | | | | | | | | | |
|---|---|---|---|---|---|---|---|---|---|---|
| | 2 | 3 | 4 | 5 | 6 | 7 | 8 | 9 | 10 | 11 |
| Number of cycles | 4 | 4 | 4 | 2 | 6 | 2 | 7 | 3 | 2 | 1 |
| Amount of syrup (kg) | 0.5 | 0.6 | 0.7 | 0.7 | 0.8 | 0.6 | 0.4 | 0.2 | 0.1 | wax |
| 1^{st} wait (min) | 0.5 | 1.0 | 1.5 | 1.0 | 2.0 | 1.0 | 2.5 | 5.0 | 5.0 | |
| SweetPearl ® P35 (kg) | 0.4 | 0 | 0 | 0 | 0 | 0 | 0 | 0 | 0 | |
| Flavoring (g) | 0 | 0 | 0 | 88 | 0 | 88 | 0 | 0 | 0 | |
| 2^{nd} wait (min) | 1.0 | 0 | 0 | 1.0 | 0 | 1.0 | 0 | 0 | 0 | 5 |
| Drying (min) | 2 | 3.5 | 4 | 3.5 | 3.0 | 2.5 | 2.0 | 0 | 0 | 10 |
| Air (flow rate 15 m³/min) | direct | direct | direct | direct | direct | direct | direct | direct | direct | direct |
| Air temperature (° C.) | 25 | 28 | 30 | 32 | 35 | 30 | 28 | 25 | 25 | 25 |
| Turbomixer speed (rpm) | 10 | 10 | 11 | 11 | 11 | 11 | 11 | 11 | 11 | 11 |

Mint flavoring was added to the surface of the cores during phases 5 and 7.

The process is performed so as to obtain a degree of enlargement of 25%.

### Example 2

This example relates to the evaluation of the organoleptic qualities of the chewing gums obtained according to Example 1 via a panel of 15 people trained in the tasting and grading of chewing gums.

Chewing gum according to the invention contains 9% maltitol SweetPearl® P700 and the control chewing gum does not contain any at all.

The panel was invited to grade from 0 to 5 the crunchiness of the chewing gums every 20 seconds for 3 minutes, 5 being the maximum crunchiness and 0 corresponding to a total absence of crunchiness (once the coating has been consumed and only the base gum remains).

The products are presented in random order, and are coded with a 3-figure number so that the panelists are not influenced either by the knowledge of the products or by their codes. The tastings are performed in a sensory analysis laboratory.

At T+0, the chewing gum is placed in the mouth and at the same time the stopwatch is started. Chewing then begins. The crunchiness is noted every 20 seconds until all the crunchiness has disappeared and only the base gum remains in the mouth.

The crunchiness corresponds to a high level of fracturability of the product. The fracturability is a mechanical texture property associated with the cohesion and the hardness and also with the force needed to erode or break a product. It is evaluated by applying a sudden force to a product placed between the teeth (standard NF EN ISO 5492-November 2009). The noise that the chewing gum makes on chewing reveals the crunchiness of the product.

The data is processed by statistical processing (ANOVA and mean comparison tests are performed on the means obtained at each time interval).

It emerges that:
The crunchiness of the two chewing gums is identical and maximum at T=0; and is minimal beyond 120 seconds.
A significant difference is observed between 40 and 60 seconds. The chewing gums according to the invention are still graded as being very crunchy (between 4 and 3), whereas the control chewing gums have already lost more than half of their crunchiness at 40 seconds (mean grade of 1.5 attributed).
At 80 seconds, the control chewing gums have lost all their crunchiness (grade of zero attributed), whereas the chewing gums according to the invention are still graded as having a crunchiness of 1.5, or even 2.
It takes 120 seconds for the chewing gums according to the invention to lose all their crunchiness.

This example shows that there is indeed a long-lasting effect of the crunchiness with the chewing gums obtained according to the present invention.

### Example 3

This example relates to the manufacture of a chewing gum composition according to the invention comprising a base gum, a flavoring and a polyol in the form of a powder of variable particle size, and a sugar-free coating.

The control was prepared with a chewing gum composition not containing any polyol particles of coarse particle size.

Three particle sizes of polyol powder were tested: 450 μm, 700 μm and 800 μm.

All the percentages are expressed relative to the total weight of the chewing gum composition used.

The centers thus obtained were then sweet-coated.

1. Preparation of the Chewing Gum Compositions

### Ingredients Used in the Chewing Gum Compositions

| | | Test 1 | Test 2 | Test 3 |
|---|---|---|---|---|
| | Control | 450 μm | 700 μm | 800 μm |
| Ingredients | (%) | (%) | (%) | (%) |
| Base gum BG Optima | 30 | 30 | 30 | 30 |
| (Cafosa) | | | | |
| SweetPearl ® P35 | 60.60 | 50.50 | 50.50 | 50.50 |
| Maltitol powder | — | 9 | 9 | 9 |
| Maltitol syrup | 7 | 7.50 | 7.50 | 7.50 |
| Lycasin ® 85/55 | | | | |
| Glycerol | 0.50 | 0.35 | 0.35 | 0.35 |
| Mint/vanilla liquid | 1.50 | 1.50 | 1.50 | 1.50 |
| flavoring | | | | |
| Mint/vanilla powder | 0.20 | 1 | 1 | 1 |
| flavoring | | | | |
| Intense sweetener | 0.20 | 0.15 | 0.15 | 0.15 |
| (Aspartame) | | | | |
| TOTAL | 100 | 100 | 100 | 100 |

SweetPearl® P35 is a crystalline maltitol powder sold by the Applicant, with a very fine particle size of about 35 μm.

The procedure for preparing the control chewing gum compositions and the chewing gum compositions according to the invention is identical to that described in Example 1.

Similarly, once the centers were obtained, the same procedure for sweet-coating as that described in Example 1 was applied.

The sweet-coating process was performed so as finally to obtain a degree of enlargement of 25% on the 4 chewing gums.

2. Evaluation of the Organoleptic Qualities of the 4 Chewing Gums

The chewing gums according to the invention contain, respectively, 9% maltitol with a particle size of 450 μm, 700 μm and 800 μm.

The control chewing gum does not contain any at all.

The panel of 15 people trained in the tasting and grading of chewing gums was invited to grade from 0 to 5 the crunchiness of the chewing gums every 20 seconds for 3 minutes, 5 being the maximum crunchiness and 0 corresponding to a total absence of crunchiness (once the coating has been consumed and only the base gum remains for the control in particular).

The products are presented in random order, and are coded with a 3-figure number so that the panelists are not influenced either by knowledge of the products or by their codes. The tastings are performed in a sensory analysis laboratory.

At T+0, the chewing gum is placed in the mouth and at the same time the stopwatch is started. Chewing then begins. The crunchiness is graded every 20 seconds until all the crunchiness has disappeared and only the base gum remains in the mouth.

The crunchiness corresponds to a high level of fracturability of the product. The fracturability is a mechanical texture property associated with the cohesion and the hardness and also with the force needed to erode or break a product. It is evaluated by applying a sudden force to a product placed between the teeth (standard NF EN ISO 5492-November 2009). The noise that the chewing gum makes on chewing reveals the crunchiness of the product.

The data is processed by statistical processing (ANOVA and mean comparison tests are performed on the means obtained at each time interval).

It emerges that:
The crunchiness of the four chewing gums is identical and maximum at T=0; and is minimal beyond 120 seconds.
A significant difference is observed between 40 and 60 seconds. The chewing gums according to the invention are still graded as being very crunchy (between 4 and 3), whereas the control chewing gums have already lost more than half of their crunchiness at 40 seconds (mean grade of 1.5 attributed).
For the chewing gums according to the invention, between 40 and 60 seconds, the chewing gums of test 2 are graded 4 whereas those of tests 1 and 3 are graded respectively 2.5 and 3. They have already lost their crunchiness.
At 80 seconds, the control chewing gums have lost all their crunchiness (grade of zero attributed), whereas the chewing gums according to the invention are still graded as having a crunchiness of 1 and 1.5, respectively, for tests 1 and 3 and of 2 for test 2.
It takes 120 seconds for the chewing gums according to the invention to lose all their crunchiness.

This example shows that there is indeed a long-lasting effect of the crunchiness with the chewing gums obtained according to the present invention, on the one hand, but above all that the chewing gums prepared with a maltitol powder having a particle size of 700 μm are those that have the greatest crunchiness and the longest long-lasting effect of this crunchiness.

There is indeed therefore a direct impact of the particle size of the polyol powder used on the crunchiness.

### Example 4

This example relates to the manufacture of a chewing gum composition according to the invention comprising a base gum, a flavoring and a polyol in the form of a powder of variable particle size: 500 μm and 700 μm and by testing two different polyols, and a sugar-free coating.

Two polyol powders with a particle size of 500 μm and 700 μm were thus tested for two different polyols: maltitol and isomalt.

All the percentages are expressed relative to the total weight of the chewing gum composition used.

The centers thus obtained were then sweet-coated.

1. Preparation of the Chewing Gum Compositions

### Ingredients Used in the Chewing Gum Compositions

| | Test 1 (%) | Test 2 (%) | Test 3 (%) | Test 4 (%) |
|---|---|---|---|---|
| | maltitol | maltitol | isomalt | isomalt |
| Ingredients | 500 μm | 700 μm | 500 μm | 700 μm |
| Base gum BG Optima | 30 | 30 | 30 | 30 |
| (Cafosa) | | | | |
| SweetPearl ® P35 | 50.50 | 50.50 | 50.50 | 50.50 |
| Maltitol powder | 9 | 9 | 9 | 9 |
| Maltitol syrup | 7.50 | 7.50 | 7.50 | 7.50 |
| Lycasin ® 85/55 | | | | |
| Glycerol | 0.35 | 0.35 | 0.35 | 0.35 |
| Mint/vanilla liquid | 1.50 | 1.50 | 1.50 | 1.50 |
| flavoring | | | | |
| Mint/vanilla powder | 1 | 1 | 1 | 1 |
| flavoring | | | | |
| Intense sweetener | 0.15 | 0.15 | 0.15 | 0.15 |
| (Aspartame) | | | | |
| TOTAL | 100 | 100 | 100 | 100 |

SweetPearl® P35 is a crystalline maltitol powder sold by the Applicant, with a very fine particle size of about 35 μm.

The procedure for preparing the chewing gum compositions according to the invention is identical to that described in Example 1.

Similarly, once the centers were obtained, the same procedure for sweet-coating as that described in Example 1 was applied.

The sweet-coating process was performed so as finally to obtain a degree of enlargement of 25% on the 4 chewing gums according to the invention.

2. Evaluation of the Organoleptic Qualities of the 4 Chewing Gums

The chewing gums according to the invention contain, respectively, 9% of maltitol with a particle size of 500 μm and 700 μm and of isomalt with a particle size of 500 μm and 700 μm.

The same test for evaluating the organoleptic qualities as that described in Examples 2 and 3 was used, on a panel of 15 people trained in the tasting and grading of chewing gums.

It emerges that:
The crunchiness of the four chewing gums is identical and maximal at T=0; and is minimal beyond 120 seconds.
A difference is already observed between 40 and 60 seconds. The chewing gums of test 2 are still graded as being very crunchy (graded 4), whereas the chewing gums of tests 1, 3 and 4 have already lost a little crunchiness. They are graded, respectively, 3, 2.5 and 2.5.
At 80 seconds, the same difference in crunchiness is noted. Test 2 is still perceived as being the crunchiest (grade 2.5 or even 3), whereas the other three tests are graded, respectively, 1.5, 1.5 and 2.
It takes 120 seconds for the chewing gums according to the invention to lose all their crunchiness.

This example shows that not only is the nature of the polyol important, but also that the particle size has an impact on the crunchiness of the products.

During the first 60 seconds, it is the chewing gums prepared with maltitol which are crunchier than those prepared with isomalt, with, in addition, a superiority of the chewing gums prepared with maltitol 700 μm relative to the chewing gums prepared with maltitol 500 μm.

When the chewing has reached 80 seconds, it would appear that it is rather the size of the particles of the polyol powder that influences the perceived sensation of crunchiness. Specifically, the two tests 2 and 4 performed with polyol powders 700 μm in diameter are graded as being the crunchiest, with, in addition, a superiority for the chewing gums containing maltitol 700 μm relative to those containing isomalt 700 μm.

There is indeed therefore a direct impact of the particle size of the polyol powder used, and also of the nature of the polyol used, on the final crunchiness of the chewing gums obtained. The crunchiest chewing gums are those with a maltitol powder with a particle size of 700 μm.

### Example 5

This example relates to the study of the stability of the chewing gum compositions according to the invention over time.

The chewing gum compositions tested are those prepared in the preceding Example 4.

They were compared with a control chewing gum composition not containing any polyol particles of coarse particle size.

All the chewing gums were left in the open air in a cupboard at normal temperature of about 20° C. Samples were taken at T=0 and then every month for 6 months.

The panel of 15 people trained in the tasting and grading of chewing gums was invited to grade from 0 to 5 the crunchiness of the chewing gums for the first 10 seconds of chewing, 5 being the maximum crunchiness and 0 corresponding to a total absence of crunchiness. The products are presented in random order, and are coded with a 3-figure number so that the panelists are not influenced either by knowledge of the products or by their codes. The tastings are performed in a sensory analysis laboratory.

At T+0, the chewing gum is placed in the mouth and at the same time the stopwatch is started. Chewing then begins. The crunchiness is graded after 10 seconds of chewing. This test makes it possible to see whether, from the very point of placing in the mouth and the start of chewing, there is already loss of the crunchiness.

The crunchiness corresponds to a high level of fracturability of the product. The fracturability is a mechanical texture property associated with the cohesion and the hardness and also with the force needed to erode or break a product. It is evaluated by applying a sudden force to a product placed between the teeth (standard NF EN ISO 5492-November 2009). The noise that the chewing gum makes on chewing reveals the crunchiness of the product.

The data processing is performed by statistical processing (ANOVA and mean comparison tests are performed on the means obtained at each time interval).

It emerges that:
The crunchiness of the four chewing gums according to the invention and also that of the control chewing gum is identical and maximum at T=0 day. After 10 seconds of chewing, the control has already lost its crunchiness (grade of 4), whereas the other four chewing gums according to the invention are still graded 4.5 or even 5.
After one month and two months, the crunchiness of the control chewing gums is judged as being 3.5, whereas that of the four tests is still graded as being 4.5 or even 5.
After 3 months, the control chewing gums are graded 3. The two tests containing isomalt are graded as being 4, and the two tests containing maltitol are graded 4.5.
At 4 months, no change relative to the situation at 3 months was noted regarding the crunchiness.
At 5 months and six months, the control has lost its crunchiness since it is graded as being 2. The two tests containing isomalt and similarly those containing maltitol have not lost their crunchiness, and still have more than satisfactory levels of crunchiness, since they are graded 4 and 4.5, respectively, irrespectively of the particle size of the powder used.

Thus, the chewing gum compositions according to the invention are more stable over time than a control composition not containing particles of a certain particle size.

1-16. (canceled)

17. A non-cariogenic chewing gum composition with improved crunchiness, comprising a base gum, a flavoring, a non-cariogenic carbohydrate in the form of a powder with a mean particle size greater than 300 μm and a sugar-free coating.

18. The composition of claim 17, wherein the non-cariogenic carbohydrate particles have a mean particle size of from 500 μm to 800 μm.

19. The composition of claim 17, said composition comprising between 5% and 20% of a non-cariogenic carbohydrate powder with a mean particle size greater than 300 μM.

20. The composition of claim 17, wherein the carbohydrate is a polyol or an unfermentable saccharide.

21. The composition of claim 20, wherein the unfermentable saccharide is selected from the group consisting of isomaltulose, xylose, xylulose, allulose, arabinose, leucrose, tagatose, trehalulose and raffinose.

22. The composition of claim 17, wherein the carbohydrate is a polyol.

23. The composition of claim 22, wherein the polyol is selected from the group consisting of sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM), alpha-D-glucopyranosyl-1,1-sorbitol (=1,1-GPS) and mixtures thereof.

24. The composition of claim 22, wherein the polyol is selected from the group consisting of maltitol, xylitol, sorbitol type 20/60, isomalt, isomalt of type M, erythritol, and mixtures thereof.

25. The composition of claim 22, wherein the polyol powder is a crystalline maltitol powder with a maltitol richness of greater than 99.5% by weight, having:
a volume-based particle size distribution, determined by laser granulometry, having:
fewer than 20% of particles smaller than 200 μm in size,
fewer than 6% of particles smaller than 100 μm in size, and
fewer than 2% of particles smaller than 40 μm in size,
a flow value of less than or equal to 10 seconds, and
an aerated density greater than 0.85 g/ml.

26. The composition of claim 17, said composition comprising:
from 15% to 40% of base gum,
from 65% to 80% of polyols in pulverulent and/or liquid form, of which at least 5% to 20% are in the form of a polyol powder with a mean particle size greater than 300 μm, and
from 0.2% to 3% of a flavoring agent,
and a sweet coating.

27. A process for manufacturing a non-cariogenic sweet-coated chewing gum, comprising the following steps:
manufacture of a chewing gum composition by mixing at least one base gum, a flavoring and a non-cariogenic carbohydrate in the form of a powder with a mean particle size greater than 300 μm,
extrusion of the preceding mixture,
rolling,
cutting,
cooling, and
sweet-coating of the centers thus obtained.

28. The process of claim 27, wherein the sweet-coating step comprises one or more cycles, each cycle comprising a phase of applying a sweet-coating syrup comprising one or more polyols to the centers, a rotating phase for distributing said syrup on the centers, and a phase of drying each new layer of syrup on the coated centers by blowing with hot, dry air.

29. The process of claim 27, wherein the non-cariogenic carbohydrate particles have a mean particle size from 500 to 800 μm.

30. The process of claim 27, wherein the chewing gum composition comprises between 5% and 20% of a non-cariogenic carbohydrate powder with a mean particle size greater than 300 μm.

31. The process of claim 27, wherein the carbohydrate is a polyol or an unfermentable saccharide.

32. The process of claim 31, wherein the unfermentable saccharide is selected from the group consisting of isomaltulose, xylose, xylulose, allulose, arabinose, leucrose, tagatose, trehalulose and raffinose.

33. The process of claim 27, wherein the carbohydrate is a polyol selected from the group consisting of sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM), alpha-D-glucopyranosyl-1,1-sorbitol (=1,1-GPS) and mixtures thereof.

34. The process of claim 27, wherein the sweet-coating step is performed until a degree of enlargement of between 25% and 40% is obtained.

35. The process of claim 28, wherein the sweet-coating syrup applied to the center further comprises binders, colorants or sweeteners.
